(19) United States
(12) Patent Application Publication
(10) Pub. No.: US 2014/0330606 A1
(43) Pub. Date: Nov. 6, 2014

(54) SYSTEM AND METHOD FOR SCHEDULING

(71) Applicant: GENERAL ELECTRIC COMPANY, Schenectady, NY (US)

(72) Inventors: Martin PAGET, Saint Johns, FL (US); Aaron MITTI, Atlanta, GA (US)

(73) Assignee: GENERAL ELECTRIC COMPANY, Schenectady, NY (US)

(21) Appl. No.: 13/886,396

(22) Filed: May 3, 2013

(51) Int. Cl. G06Q 10/06

(52) U.S. Cl. CPC G06Q 10/06311
USPC 705/7.18

(57) ABSTRACT

A method is presently disclosed that includes receiving asset information for a plurality of assets, and each asset has defined inspection requirements; determining a list of inspection tasks for each of the plurality of assets based on the inspection requirements; receiving workforce information for a plurality of members of a workforce who perform inspection tasks on the assets, wherein the workforce information further includes one or more workforce constraints; determining a schedule for the inspection tasks based on the asset information and the workforce information subject to the workforce constraints.

### BACKGROUND

1. Technical Field

The subject matter disclosed herein relates to systems and methods of determining a schedule for performing inspection tasks on a plurality of assets.

2. Discussion of Art

Transportation systems may include a variety of assets, such as traffic control devices, tracking systems, and vehicles. In a railroad environment, such assets may include wayside devices, grade crossing devices, locomotives, and railcars. These assets may need periodic inspection. Inspections may be based on government requirements, manufacturer recommendations, or industry standards that can align with reliability, safety, and performance goals. The inspection requirements may be met by members of the workforce, but which have various limitations and restrictions on their availability, cost, and capabilities of individual members of the workforce plus the availability of the asset, and/or required inspection equipment. There is a burden associated with planning and managing inspections based on the number of assets, number of inspections, and variable workforce capacity. Furthermore, the workforce capacity may fluctuate due to a variety of circumstances, such as demands on the workforce to address emergency or high priority tasks not associated with inspection activities, overtime work, limitations placed on available working hours such as Hours of Service regulations, or other workforce constraints. It may be desirable to have a system for determining a schedule for performing inspection tasks that differs from the systems and methods that are currently available.

### BRIEF DESCRIPTION

In an embodiment, a method comprises receiving asset information for a plurality of assets; each asset has respective defined inspection requirements. The method further comprises determining a respective list of inspection tasks for each of the plurality of assets based on the inspection requirements, and receiving workforce information for a plurality of members of a workforce who perform the inspection tasks on the assets. The workforce information further includes one or more workforce constraints. The method further comprises determining a schedule for the inspection tasks based on the asset information and the workforce information, subject to the workforce constraints.

Also disclosed is a system that includes a controller, an asset database system containing asset information for a plurality of assets, an inspection requirements database system, and a workforce database system. The inspection requirements database system contains information of defined inspection requirements of the plurality of assets. The controller is configured to generate inspection tasks for the plurality of assets based on the defined inspection requirements. The workforce database system contains workforce information for a plurality of members of a workforce who perform the inspection tasks on the assets. The workforce information further includes workforce constraints. The controller is configured for communication with the asset database system, the inspection requirements database system, and the workforce database system. The controller is operable to determine a schedule for the inspection tasks based on the asset information and the workforce information, subject to one or more of the workforce constraints, equipment constraints, or environmental constraints.

### BRIEF DESCRIPTION

Reference is made to the accompanying drawings in which particular embodiments of the invention are illustrated as described in more detail in the description below, in which:

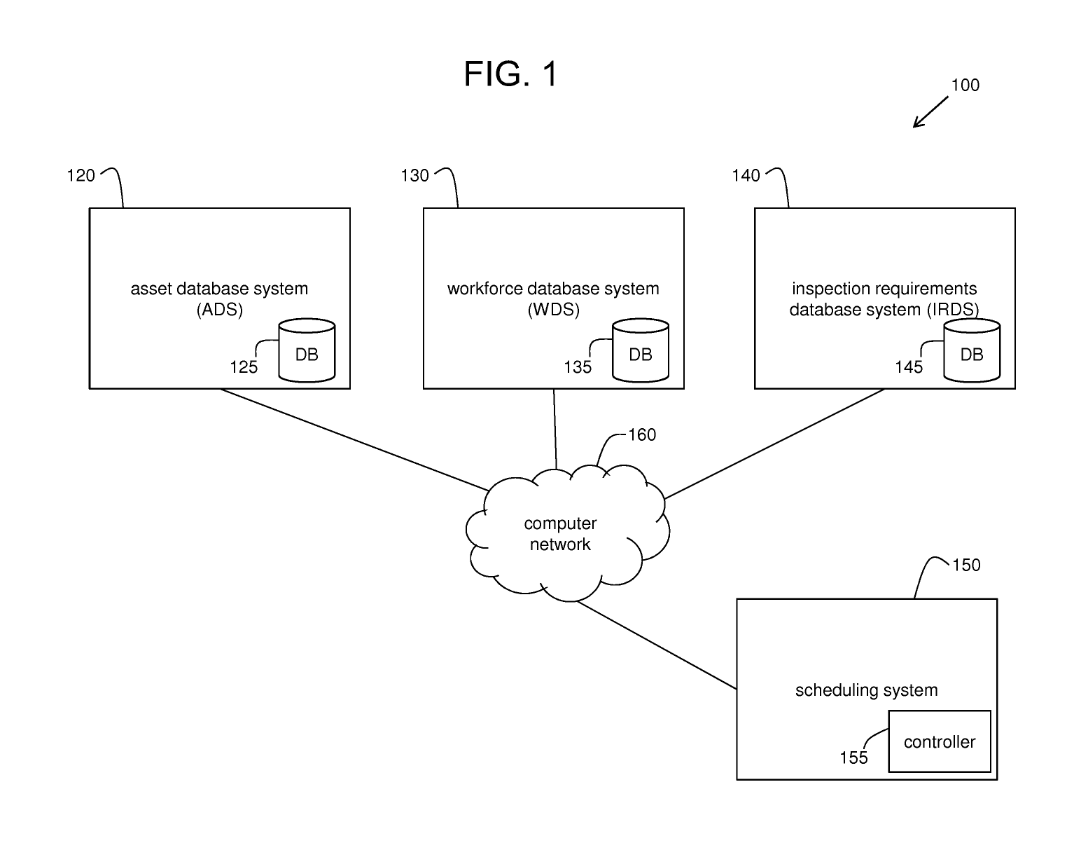

FIG. 1 is a schematic block diagram of an exemplary embodiment of a system for determining a schedule for performing inspection tasks on a plurality of assets.

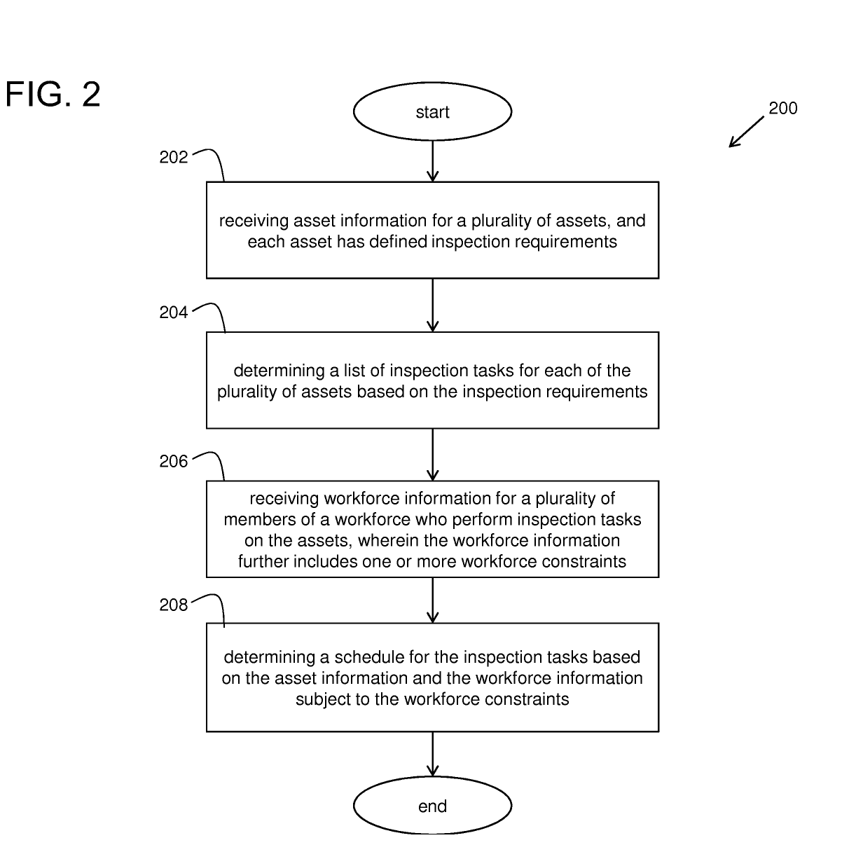

FIG. 2 is a flowchart of an exemplary embodiment of a method for determining a schedule for performing inspection tasks on a plurality of assets.

### DETAILED DESCRIPTION

Embodiments of the present disclosure relate to systems and methods for scheduling a workforce to perform tasks on a plurality of assets. The systems and methods described herein are illustrated in the context of a railroad environment including both mobile assets, such as rail cars, and fixed assets, such as crossings and switches. Embodiments of the invention however may also be applied to other industries or environments, for example, shipping ports, warehouses, or commercial vehicle fleets, along with their corresponding assets.

The term “asset” refers to stationary equipment and mobile equipment. Examples of assets include, but are not limited to, gates and crossings on a rail line, vehicles (such as, mining equipment, marine vessels, aircraft, automobiles, and locomotives), containers/trailers, office equipment (such as printers and electronic devices), industrial equipment (such as power generators and motors), and military and construction equipment.

Asset information can include informational items such as the type of asset, serial numbers, and the asset history, asset status, and/or asset health. For example, the asset status can include whether the asset is in-service, out-of-service, retired, or the like.

The term “inspection requirement” refers to a task that is designated to be performed on or in connection with an asset. Some inspection requirements may be imposed by government regulation. Inspection requirements may come from the asset manufacturer or service provider, and may sometimes be coupled with a warranty or guarantee. Other inspection requirements may be defined through standard operating procedures established by an industry. Inspection requirements may be defined by previous inspection history or maintenance/repair history and may change over an expected life of an asset, with different requirements being associated with different points along that product life. Inspection requirements may include one or more of observation, testing, repairing/replacing, updating, cleaning, preventative maintenance, record keeping or data collection, or other tasks.

The term “workforce” refers to individuals expected to perform the inspection tasks corresponding to the inspection requirements. The term “inspection equipment” refers collectively to resources (such as replacement parts) and test equipment needed by the individual(s). The term “work conditions” includes external aspects necessary to perform an inspection, such as availability of road or track time, garage space, fuel, computer/communication/data access, and/or the environment (such as weather conditions).

The term “workforce constraints” may be applied to the individuals, the inspection equipment, or the work conditions. Regarding the individuals, it may include limits on the availability of the individuals to perform the inspection tasks corresponding to the inspection requirements; may be temporal, such as designated days or hours when a given worker is unavailable; or may be a capability limitation. A capability limitation may include lack of certification, lack of training, lack of necessary equipment, or other limitations imposed on various members of the workforce, such as hours of service requirements or similar regulations. (For example, some hours of service regulations are defined in the U.S. under Title 49, Part 228; 49 CFR 228.) As applied to inspection equipment, it may include limits on the availability, or it may be geographic or functional limitations (such as needing data communication connectivity), or may be configuration-based (such as needing an adapter plug or a software patch). Environmental workforce constraints may include weather, particularly temperature, humidity, and light levels—and these may be further based on considerations for the safety or comfort of the individual or may be elements of the inspection (an electrical test may be precluded on rainy days unless shelter is available, for example).

Workforce constraints further may be designated as hard or soft constraints. A hard constraint is one that may not be overridden, such as the unavailability of a given worker due to illness. A soft constraint is one which may be able to be overridden, such as a preferred maximum work hours in a given day that may be exceeded by allowing for overtime and incurring additional cost. In addition, workforce constraints may be short-term limitations, such as a planned vacation day. Alternatively, workforce constraints may represent long-term limitations, such as an employee's job code that defines what tasks the employee is available to perform.

“Software” or “computer program” as used herein includes, but is not limited to, one or more computer readable and/or executable instructions that cause a computer, controller or other electronic device to perform functions, actions, and/or behave in a desired manner. The instructions may be embodied in various forms such as routines, algorithms, modules or programs including separate applications or code from dynamically linked libraries. Software may be implemented in various forms such as a stand-alone program, a function call, a servlet, an applet, an application, instructions stored in a memory, part of an operating system or other type of executable instructions.

“Computer”, “processing element”, or “controller” as used herein includes a programmed or programmable electronic device that can run software.

FIG. 1 is a schematic block diagram of an embodiment of a system 100 illustrating aspects of the invention. The system may schedule a workforce to complete inspection requirements on a plurality of assets. The system includes an asset database system (ADS) 120 having at least one database (DB) 125. The ADS contains asset information for a plurality of assets that each have respectively defined inspection requirements. The system has an inspection requirements database system (IRDS) 140 having at least one database 145. The IRDS contains inspection requirements from which inspection tasks are generated for the assets represented in the ADS. The system also includes a workforce database system (WDS) 130 having at least one database 135. The WDS contains workforce information for a plurality of members of a workforce who perform the inspection tasks on the plurality of assets. The WDS may also contain workforce constraints. In embodiments, the ADS, IRDS, and/or WDS may be implemented in a single database system or implemented in two or more database systems as desired.

The ADS, the IRDS and the WDS communicate with a scheduling system 150 having a controller 155. The controller 155 may include a processor. Using the information from the ADS, IRDS and WDS, the scheduling system determines an inspection task schedule based on at least the asset information, inspection tasks, and the workforce information, subject to the workforce constraints. For example, the controller 155 may be configured to generate inspection tasks for the plurality of assets based on the defined inspection requirements, and to determine a schedule for the inspection tasks based on the asset information and the workforce information, subject to one or more of the workforce constraints, equipment constraints, or environmental constraints.

In an embodiment, the system is applied to railroad assets. Each asset may be represented in the ADS by one or more records that contain pertinent information about the asset. For example, the asset may have a unique identifier. The asset may also be assigned an asset type, where inspection requirements are specific to the asset type. For example, assets of the type “switch” may require certain inspections, whereas assets of the type “signaling device” may require different inspections. In addition, fixed assets may have a defined geographic location. Mobile assets, such as rail cars, may have a defined geographic location, which may be the most recent location, a projected location, or a series of projected locations representing where the mobile assets are expected to be at a given time. In some embodiments, the system communicates with an asset and receives data from the asset corresponding to the geographic location of the asset. The asset may also communicate vector data such as the direction of travel and speed of the asset, which may be used to project the location of the asset at a future time. In yet other embodiments, an operator of an asset may communicate the asset's current location, and may communicate an expected location for the asset at a future time. The location information received or estimated by the system may be used in determining the schedule for inspection tasks.

Each asset may have one or more inspection requirements. By way of illustration, the inspection of certain railroad assets is required according to governmental regulations that establish inspections which must be performed on a periodic basis. A given asset may have a 30-day inspection having a first list of tasks, a 90-day inspection requirement having a second list of tasks, and a 360-day inspection requirement having a third list of tasks. The tasks may be different for each type of inspection, and for each type of asset. For some assets, each 30-day inspection must be performed no later than 30 days after the preceding 30-day inspection. Similarly, each 90- and 360-day inspection must be performed no later than 90- or 360-days following the preceding 90- or 360-day inspection, respectively. Consequently, for an asset with 30-day, 90-day and 360-day inspection requirements, a member of the workforce may be required to visit that asset at least 12 times during any given 360-day period. In this example, only one asset with only three inspection requirements was considered. A railroad environment, however, may have many assets each having many inspection requirements. Moreover, multiple assets may be co-located, such as multiple gates and signals at a given railroad crossing. The ADS 120 in combination with the IRDS 140 contains information about each of these assets allowing the scheduling system 150 to determine a list of inspection tasks for each of the plurality of assets based on the inspection requirements for each asset. The scheduling system 150 may then determine a schedule for the inspection tasks to be performed.

The inspection tasks described above are performed by members of a workforce. The members of the workforce may be employees, contractors, or any other personnel to be scheduled by the scheduling system 150. In some embodiments, various inspection tasks may require special inspection equipment or track time, and the inspection equipment or availability of track time may be regarded as a member of the workforce. In these embodiments, the workforce may include both people and equipment necessary to perform the inspection tasks.

The workforce information stored in the WDS 130 (or associated DB) also includes information about the members of the workforce that may be used to determine a schedule for the inspection tasks. In one embodiment, the workforce information includes an hourly rate for each member of the workforce. The scheduling system 150 may thus compute an expected cost for a given member of the workforce to perform a given inspection task based on the expected duration of the task and that member's hourly rate. Similarly, the workforce information may include overtime hourly rates for those members who are eligible to work overtime. In other embodiments, the workforce information may also include details of union agreements relating to tasks that may be performed by each member of the workforce, the hours each member may be asked to work, or other factors relative to the scheduling of the workforce to perform the inspection tasks. The workforce information may also include data representing the skill set and qualifications of a given member of the workforce. In addition, the workforce information may include an efficiency or expertise rating. The efficiency or expertise rating may be used to project the time required for a given employee to complete a task. For example, a member of the workforce may have an efficiency factor of 1.25 indicating that this employee is 25% more effective at completing certain tasks due to experience, training, knowledge of certain territories or equipment, or the like. The scheduling system 150 may use the efficiency or expertise rating, in combination with other workforce information, to more accurately project the time required for the completion of certain tasks by different employees. The workforce information may be updated over time to reflect changes in hourly rates, skill sets, qualifications, efficiency and expertise rating, or other factors to improve the scheduling process.

As previously discussed, the workforce constraints impose limitations on the availability or allocation of members of the workforce to the inspection tasks. In a railroad environment, maintenance personnel may be subject to a limitation on the number of hours that a given employee may work in any period. Similarly, personnel may be required to have a minimum number of hours off-duty in between shifts. The workforce information includes these and other workforce constraints that may be factored into the scheduling of inspection tasks. In addition, information specific to a given individual may be included as a workforce constraint. For example, an individual may be unavailable due to illness, vacation, training or any other reason that effectively removes the individual from the pool of members available to perform the inspection tasks.

Based at least on the asset information and the workforce information, the scheduling system 150 determines a schedule for the inspection tasks subject to the workforce constraints. In one embodiment, the scheduling system 150 determines the schedule for the inspection tasks, at least in part, by reducing an expected cost for the workforce to perform the inspection tasks on the assets. The expected cost for the workforce to perform the inspection tasks may be calculated using the determined list of inspection tasks for each asset and the workforce information. In one example, the expected cost for a 30-day inspection task is determined by the expected duration of that task and the hourly rate of the workforce member scheduled to complete the task. If a workforce member with a different hourly rate is assigned to the task, the expected cost for that task may increase or decrease accordingly. In a similar manner, an efficiency or expertise factor may be applied to adjust the expected time to complete the task. The time and labor rates for various members of the workforce may be analyzed to reduce the expected cost for performing the inspection tasks on the assets. In one embodiment, the expected cost for a given task may be equal to the hourly rate multiplied by the expected time and divided by the efficiency factor for the employee assigned to the task. In other embodiments, the expected cost may be determined, at least in part, based on factors such as determining the best utilization of a reduced workforce size, minimizing travel cost or minimizing fuel consumption to reduce carbon emissions. In yet other embodiments, the expected cost may be determined, at least in part, based on a compliance risk factor that increases the expected cost when a test is completed on the last day the test is due. In this manner, objectives for human and physical resource allocation as well as schedule or compliance priorities may be incorporated into the expected cost analysis allowing the system to determine a schedule based upon multiple considerations.

By allocating workforce members to the inspection tasks, the scheduling system determines an expected cost for the workforce to perform the inspection tasks. In embodiments, the scheduling system reduces the expected cost for the workforce to perform the inspection tasks by changing the sequence of the tasks and/or the allocation of workforce members to specific tasks. As discussed above, a given asset may have 30-day, 90-day, and 360-day inspection requirements resulting in at least 12 visits to the asset by a member of the workforce. In prior systems, the 90-day and 360-day inspections may have been scheduled to coincide with the 30-day inspections on the assumption that performing multiple inspections on a single visit to an asset would produce an efficient schedule. The presently disclosed system, however, considers multiple factors as discussed above, and may produce an improved schedule as compared to the prior systems. In one example, the system may accelerate an inspection of a certain first asset to coincide with an inspection due on a second asset located in close proximity to the first asset. In this manner, the system considers inspection requirements for the plurality of assets to determine an improved schedule for the collection of assets as a whole. In one embodiment, the system improves upon the schedule by generating a first work schedule for the workforce to perform inspection tasks subject to the workforce constraints and asset inspection requirements, and then generating a second work schedule where the expected cost for the workforce to implement the second work schedule is less than an expected cost for the workforce to implement the first work schedule. The system may continue to generate successive work schedules with iteratively lower expected costs until an acceptable schedule is achieved.

In some embodiments, the scheduling system 150 forecasts future inspection tasks for each of the plurality of assets based on the inspection requirements. Future inspection tasks may be defined as those inspection tasks beyond a certain date, whereas current inspection tasks are those that fall prior to the date. Alternatively, future inspection tasks may be those tasks which are contingent upon completion of a task that has not yet been performed. In various embodiments, the system may determine a schedule for the inspection task at least in part, by reducing an expected cost for the workforce to perform both the current inspection tasks and the future inspection tasks. By dividing tasks into current, or near term tasks, and future, or longer term tasks, the schedule may be adjusted to balance both near term and longer term costs. In yet another embodiment, the scheduling system generates both a current work schedule and a future work schedule for the workforce to perform a current asset inspection subject to the workforce constraints and asset inspection requirements. The scheduling system may then modify the current work schedule to reduce an expected cost for the workforce to implement the future work schedule.

In yet another embodiment, each of the plurality of assets have a designated geographic location and the scheduling system 150 determines the schedule for the inspections by reducing a travel cost for the workforce in performing the inspection tasks on the plurality of assets at the designated geographic locations. Similar to the assets, members of the workforce may also have designated geographic locations reflecting the location of each member. In this manner, the travel cost, including distance and time, and in some embodiments other factors such as traffic conditions or estimated carbon emissions, may be factored into the determination of the schedule. In an embodiment, the scheduling system 150 allocates workforce members to inspection tasks to reduce the total travel cost for each member of the workforce. In embodiments with mobile assets, the scheduling system 150 may project the locations of both the mobile assets and the workforce members over time, and allocate workforce members to inspection tasks on mobile assets when the travel cost between the projected locations is reduced. By combining location information with other factors discussed above, the scheduling system 150 may provide an efficient schedule for the completion of the inspection tasks by the workforce. In an embodiment, at least a portion of the assets have a fixed geographic location, and the schedule for the inspection tasks may be determined by calculating a travel cost for the workforce to travel from a first location of the workforce, such as the workforce member's current location, to the fixed geographic location of the one or more assets to perform the inspection tasks on the plurality of assets. In another embodiment, at least a portion of the assets are mobile assets with variable geographic locations, and the schedule for the inspection tasks is determined, at least in part, by calculating a travel cost for moving an asset from its current location to a designated location, such as a repair depot, where the workforce may perform the required inspection task for the asset. In yet another embodiment, both the workforce and the assets may be mobile, and the schedule for the inspection tasks is determined by calculating a travel cost for moving one or both of the workforce and the assets to a designated location where the workforce may perform the inspection tasks on the asset. In this manner, the system is able to construct a schedule that accommodates both asset and workforce locations and that improves the efficiency of the schedule by taking into account the relationship between asset locations and the locations where inspection tasks are to be performed.

Over time, the system 100 receives updated asset information and workforce information. For example, upon completion of an inspection task for a given asset, the workforce member may update the asset database to reflect the completion of the inspection task. In one embodiment, upon updating the asset database the workforce member records the actual time required for that workforce member to perform the inspection task. Over time, the system may adjust the estimated time required for a given inspection task on a given asset based upon the actual performance of that task by members of the workforce. In addition, the workforce information may be updated to reflect the relative efficiency of different members of the workforce in performing certain types of inspection tasks. The feedback of actual performance data into the asset information and workforce information may enable the system to more accurately estimate the expected cost for performing the inspection tasks. In some embodiments, the system may require a workforce member to update asset information when that workforce member is in proximity to that asset. The system may thus provide a safeguard against incorrect updates and provide an audit trail demonstrating that the workforce member was at the designated geographic location of the asset when the inspection was performed.

In some embodiments, the system also receives requests for previously unscheduled tasks, such as repairs due to an unexpected failure of an asset. The need for an unscheduled task may be identified by an operator or technician, or may be triggered based on a fault signal or prognostic indicator associated with a condition of a monitored asset. An unscheduled task of this type may disrupt a previously established schedule, requiring a rescheduling of the workforce members to accommodate the unplanned work. In one embodiment, the system receives the unscheduled task and a deadline for completing the unscheduled task, and determines a new schedule for the workforce that includes the unscheduled task. In one embodiment, the new schedule is created within 60 seconds of receiving the unscheduled task so that the workforce may be promptly reprioritized pursuant to the new schedule. The system may further modify the schedule to recover the time lost due to the unscheduled task. This may involve reallocating workforce members or adjusting the sequence of tasks.

By forecasting inspection requirements and determining a schedule for both current and future inspection tasks, the system is able to proactively improve the efficiency and productivity of the workforce over time. The deadline for many inspection tasks is based upon the date when a prior inspection was completed. The system is able to forecast when future inspection(s) would be required based upon when current inspections are performed, allowing the system to drive inspections into a more efficient sequence. Further, by examining inspection requirements across the plurality of assets, the system is able to take into account the variety of assets and the variety of inspection requirements to generate an improved schedule. In a similar manner, the system may drive the alignment of tasks on multiple assets at a given location to improve the efficiency

In yet other embodiments, the system determines the schedule for performing inspection tasks based on forecasted weather conditions. In certain applications, it may not be possible to perform certain tasks under all weather conditions. Certain railroad inspections, for example, may not be performed in the rain or when the ambient temperature is outside a defined range. In these applications, the system may adjust the schedule based upon the forecast weather so that these weather-dependent tasks are scheduled for a time when the weather conditions are appropriate to the task.

In yet another embodiment, in addition to determining a schedule, the system may track the hours worked by one or more members of the workforce to monitor compliance with hours of service limitations. The hours of service limitation may be a hard constraint, such that when a workforce member has reached the limit, that member must discontinue working More often, however, the hours of service limitation is a soft constraint that may be overridden when necessary, such as when responding to emergency conditions or addressing urgent repairs. The system may monitor the hours of service and generate a report identifying any task or reason for any deviation from an hours of service constraint. The system may similarly monitor compliance with inspection requirements and generate a report to demonstrate compliance with the requirements. In some cases, it may not be possible to fully comply with all inspection requirements, in which case, the system may determine a schedule based upon the severity of non-compliance, including any expected fines or other liability.

In addition to scheduling workforce members, which may be persons and/or equipment, the scheduling system may also determine a schedule based on such factors as the availability of track time or on-rail test equipment (such as a locomotive or test car). In a railroad environment, some inspections require the workforce member to have access to the railroad track, or to know the availability and predicted arrival at the asset of the on-rail test equipment. The system may interface with a scheduling, dispatch, movement planning system, or other such similar system, to determine the location of trains and/or on-rail test equipment so that inspection tasks requiring track time may be performed when the track is available, or to determine when the on-rail test equipment will be available at the asset in order to minimize waiting time. In other embodiments, the system may interface with the movement planner to redirect trains to create available track time if necessary for the performance of an inspection task. In this manner, the system may be used in combination with other systems to efficiently manage a variety of fixed and/or mobile assets.

In embodiments, the scheduling system 150 receives the asset information and the workforce information and performs a sensitivity analysis on one or more of the factors previously discussed to determine the schedule for performing the inspection tasks. Using the results of the sensitivity analysis, the system 150 determines the factors which have the greatest impact on the schedule, such as by impacting the expected cost for the workforce to perform the inspection tasks. The system may produce one or more schedules, which may be adopted according to the preferences or criteria of a given business. In addition, one or more scheduled scenarios may be determined with different assumptions about workforce or equipment availability, increased or decreased inspection requirements, or other variations contemplated for the management of the assets. Used in this manner, the system provides a scenario-based planning tool to assist in evaluating the impact of changes in the assets and workforce to aid in the management process.

Referring now to FIG. 2, a flowchart of an exemplary embodiment of a method 200 for scheduling is illustrated. In step 202, asset information is received for a plurality of assets, and each asset has defined inspection requirements. In step 204, inspection tasks are determined for each of the plurality of assets based on the inspection requirements. In step 206, workforce information is received for a plurality of members of a workforce who perform inspection tasks on the assets, and the workforce information further includes one or more workforce constraints. In step 208, a schedule is determined for the inspection tasks based on the asset information and the workforce information, subject to the workforce constraints. The method 200 may be performed by the system 100 illustrated in FIG. 1, and may be implemented as a computer program or using a combination of hardware and software resources.

In an embodiment, the system 100 determines the schedule for performing various inspections for the assets. The decision on when to perform each test or other task has an effect on the overall cost incurred in performing the required inspections. The system determines the schedule for all inspections in a given planning period while considering the constraints imposed by the inspection requirements and workforce constraints. In one embodiment, the system may use a mixed integer linear programming algorithm having an objective function to be reduced or minimized. A set of constraints may be communicated to the controller and the schedule determined based in part on the set of constraints. In an embodiment, the system initially determines a long term schedule for a long term planning period while approximating travel cost. The long term schedule may be determined to sequence the inspections to improve the cost of performing the work over a long duration, such as several weeks, months or even years. The system may then determine a short term schedule and improve the schedule to reduce costs by modeling actual travel cost for each member of the workforce. Due to the increased processing requirements, the short term schedule calculation is typically of less duration than the long term schedule. In embodiments, the short term schedule may extend for several days or weeks. The system may finally determine a daily schedule based upon the inspections that are scheduled for a given day. The daily schedule may reduce costs by determining a sequence in which inspections are to be performed so that the travel cost, as measured by one or more factors, is reduced. These factors may include fuel, distance, time, traffic conditions, weather, road or track conditions, and/or emissions levels. These emissions levels may include total exhaust levels, or may refer to one or more exhaust constituents (NOx, CO, SOx, particulate levels, and the like). The daily schedule, short term schedule, and long term schedule may be recomputed as the inspections requirements, assets, or workforce information change. In addition, the schedules may be updated based upon the completion of inspection tasks to further refine the schedule for future tasks.

In this manner the system generates a schedule for inspection tasks for one or more assets based at least in part on asset information of the assets, inspection requirements associated with the assets, and workforce information, subject to one or more of workforce constraints, equipment constraints and environmental constraints.

In another embodiment, a method comprises receiving, by one or more controllers, asset information for a plurality of assets; each asset has respective defined inspection requirements. The method further comprises determining, by the one or more controllers, a respective list of inspection tasks for each of the plurality of assets based on the inspection requirements, and receiving workforce information for a plurality of members of a workforce who perform the inspection tasks on the assets. The workforce information further includes one or more workforce constraints. The method further comprises determining, by the one or more controllers, a schedule for the inspection tasks based on the asset information and the workforce information, subject to the workforce constraints. The method may be automatically carried out by the one or more controllers. In other embodiments, the method additionally comprises carrying out the inspection tasks on the assets, according to the schedule, such that physical states of one or more of the assets are changed (e.g., from a state before inspection to a state after inspection).

In the specification and clauses, reference will be made to a number of terms having the following meanings The singular forms “a”, “an” and “the” include plural references unless the context clearly dictates otherwise. Approximating language, as used herein throughout the specification and clauses, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

The terms “including” and “having” are used as the plain language equivalents of the term “comprising”; the term “in which” is equivalent to “wherein.” Moreover, unless explicitly stated to the contrary, embodiments “comprising,” “including,” or “having” an element or a plurality of elements having a particular property may include additional such elements not having that property. Furthermore, references to “one embodiment” of the present invention are not intended to be interpreted as excluding the existence of additional embodiments that also incorporate the recited features. Moreover, certain embodiments may be shown as having like or similar elements, however, this is merely for illustration purposes, and such embodiments need not necessarily have the same elements unless specified in the claims.

This written description uses examples to disclose the invention, including the best mode, and also to enable one of ordinary skill in the art to practice the invention, including making and using any devices or systems and performing any incorporated methods. The embodiments described herein are examples of articles, systems, and methods having elements corresponding to the elements of the invention recited in the clauses. This written description may enable those of ordinary skill in the art to make and use embodiments having alternative elements that likewise correspond to the elements of the invention recited in the clauses. The scope of the invention thus includes articles, systems and methods that do not differ from the literal language of the clauses, and further includes other articles, systems and methods with insubstantial differences from the literal language of the clauses. While only certain features and embodiments have been illustrated and described herein, many modifications and changes may occur to one of ordinary skill in the relevant art. This application covers all such modifications and changes.

1. A method comprising:
receiving asset information for at least one of a plurality of assets, with each asset having respective defined inspection requirements;
determining a respective list of inspection tasks for each of the plurality of assets based on the inspection requirements;
receiving workforce information for a plurality of members of a workforce who perform the inspection tasks on the plurality of assets, wherein the workforce information further includes one or more workforce constraints; and
determining a schedule for the inspection tasks based on the asset information and the workforce information subject to the workforce constraints.

2. The method of claim 1, wherein the plurality of assets comprises mobile assets, and the method further comprises determining a projected location of one of the mobile assets at a time of an inspection task to be performed on said one of the mobile assets.

3. The method of claim 2, further comprising communicating with said one of the mobile assets and receiving at least one of location data or vector data from said one of the mobile assets.

4. The method of claim 2, further comprising receiving from an operator of said one of the mobile assets an expected location of said one of the mobile assets at a future time, wherein the projected location is determined based at least in part on the expected location.

5. The method of claim 1, wherein determining the schedule for the inspection tasks comprises analyzing at least time and labor rates to thereby reduce an expected cost for the workforce to perform the inspection tasks on the plurality of assets.

6. The method of claim 1, further comprising forecasting future inspection tasks for the plurality of assets based on the inspection requirements.

7. The method of claim 1, wherein one or more of the plurality of assets have respective fixed geographic locations, and determining the schedule for the inspection tasks comprises calculating a travel cost for the workforce to travel from a first location of the workforce to the fixed geographic locations of the one or more of the assets to perform the inspection tasks on the one or more of the assets.

8. The method of claim 1, wherein one or more of the plurality of assets are mobile assets with variable geographic locations, and determining the schedule for the inspection tasks comprises calculating a travel cost for moving at least one of the one or more of the assets to a first location of the workforce to perform the inspection tasks on the at least one of the one or more of the assets.

9. The method of claim 1, wherein determining the schedule for the inspection tasks comprises calculating a travel cost for moving the workforce to a designated location and moving the at least one of the plurality of assets to the designated location to perform the inspection tasks on the at least one of the plurality of assets.

10. The method of claim 1, wherein determining the schedule for the inspection tasks comprises calculating a travel cost for moving the workforce or one or more of the plurality of assets to a designated location, and wherein calculating the travel costs further comprises calculating a cost associated with estimated carbon emissions for moving the workforce or the one or more of the assets.

11. The method of claim 1, wherein the plurality of assets comprises railroad assets.

12. The method of claim 1, wherein the plurality of assets comprises fixed assets and mobile assets.

13. A system comprising:
a controller;
an asset database system containing asset information for a plurality of assets;
an inspection requirements database system containing information of defined inspection requirements of the plurality of assets, wherein the controller is configured to generate inspection tasks for the plurality of assets based on the defined inspection requirements; and
a workforce database system containing workforce information for a plurality of members of a workforce who perform the inspection tasks on the plurality of assets, wherein the workforce information further includes workforce constraints;
wherein the controller is configured for communication with the asset database system, the inspection requirements database system, and the workforce database system, and wherein the controller is operable to determine a schedule for the inspection tasks based on the asset information and the workforce information and subject to one or more of the workforce constraints, equipment constraints, or environmental constraints.

14. A method comprising:
generating a schedule for inspection tasks for one or more assets based at least in part on asset information of the assets, inspection requirements associated with the assets, workforce information, and subject to one or more of workforce constraints, equipment constraints, and environmental constraints.
